(19) United States
(12) Patent Application Publication
(10) Pub. No.: US 2023/0047120 A1
(43) Pub. Date: Feb. 16, 2023

(54) System, Method and Device for On-Site Rapid, Direct, and Nondestructive Analysis of a Material Sample Using a Portable High Performance Near-Infrared Spectrometer

(71) Applicant: Eurofins QTA, Inc., Des Moines, IA (US)

(72) Inventors: Ching-Hui Tseng, West Chester, OH (US); Anthony Lai, Creastview Hills, KY (US); Kirsten Kramer, Cincinnati, OH (US); Kangming Ma, Cincinnati, OH (US)

(73) Assignee: Eurofins QTA, Inc., Des Moines, IA (US)

(21) Appl. No.: 17/402,191

(22) Filed: Aug. 13, 2021

(51) Int. Cl. G01N 21/359

(52) U.S. Cl. CPC G01N 21/359; G01N 2201/0846; G01N 2021/3595

(57) ABSTRACT

A portable data collection device includes a FT-NIR spectrometer operable with a direct current (DC) power input, a hand-held probe having a large sampling area, a portable computer operable with a DC power input and configured for operation of the FT-NIR spectrometer; and a portable electric power source for providing a DC power output. The components of the portable data collection device are contained within a portable carrier. The portable data collection device is used onsite to obtain a spectra from a material sample. The spectra is sent by the portable computer of the portable data collection device to a remote computer/server. Application methods stored in a remote database analyze the spectra to obtain desired trait results for the material sample. The obtained results are stored on a remote database and can be displayed on a screen of an on-site mobile device.

### CROSS-REFERENCE TO RELATED APPLICATIONS

Not Applicable

### STATEMENT REGARDING FEDERALLY SPONSORED RESEARCH

Not Applicable

### PARTIES TO JOINT RESEARCH AGREEMENT

Not Applicable

### REFERENCE TO APPENDIX

Not Applicable

### FIELD OF THE INVENTION

The field of the present invention generally relates to nondestructive analysis of material samples and, more particularly, to such analysis of material samples using portable high performance near-infrared spectrometers.

### BACKGROUND OF THE INVENTION

Near Infrared (NIR) spectroscopy is commonly used in various industries for rapid and nondestructive quantitative or qualitative analysis. A wide variety of materials can be analyzed with NIR, in general anything organic in nature (containing carbon, hydrogen, oxygen, nitrogen bonding combinations) such as, for example but not limited to, agricultural products (e.g. grains, seeds, fruits etc.), foods and food ingredients, oils, fuels, and many other specialty chemicals. NIR spectroscopy is also used for-process reaction monitoring or testing finished products for quality control/quality assurance.

There are portable and/or handheld NIR spectroscopy devices in existence but they have a small sampling window (limited sampling surface area), low detection sensitivity, and limited spectral range and resolution. Although many of these portable devices are low cost, applications and accuracy of these instruments are limited.

High performance Fourier Transform Near Infrared (FT-NIR) spectroscopy devices typically require a relatively long optic path accommodated with large and heavy instrumentation which is placed on a benchtop in a controlled lab environment. These higher quality benchtop FT-NIR instruments can achieve a high level of performance due to high sensitivity, increased spectral resolution and ability to collect a spectrum covering the full NIR spectral range. Therefore, such instruments can be applied to a wider variety of applications with much better accuracy than the available handheld NIR devices. Accordingly, there is a need for improved portable NIR analyzer systems, methods and devices.

### SUMMARY OF THE INVENTION

Disclosed are systems, methods and devices for on-site rapid, direct, and nondestructive analysis of material samples using portable high performance NIR spectrometers that overcome at least one of the disadvantages of the prior art described above. Disclosed is a portable data collection device comprising, in combination, a portable Fourier-Transform Near-Infrared (FT-NIR) spectrometer operable with a direct current (DC) power input, a hand-held probe having a large sampling area and operably connected to the portable FT-NIR spectrometer, a portable computer operable with a DC power input and configured for operation of the FT-NIR spectrometer, a portable electric power source operably connected to the portable FT-NIR spectrometer and the portable computer for providing a DC power output to the portable FT-NIR spectrometer and the portable computer, and a carrier. The carrier contains the portable FT-NIR spectrometer, the portable computer, and the portable electric power source. An on-site mobile device is preferably used to wirelessly control and display the portable computer located within the carrier.

Also disclosed is a system for on-site nondestructive analysis of a material sample, the system comprising, in combination, a remote-site computer and a remote-site database in communication with the remote-site computer, an on-site portable data collection device, and an on-site mobile device. The on-site portable data collection device comprises a portable Fourier-Transform Near-Infrared (FT-NIR) spectrometer operable with a DC power input. a hand-held probe having a large sampling area and operably connected to the portable FT-NIR spectrometer, a portable computer operable with a DC power input and configured for operation of the FT-NIR spectrometer and operably configured to send data to and receive data from the remote-site computer, a portable electric power source operably connected to the portable FT-NIR spectrometer and the portable computer for providing a DC power output to the portable FT-NIR spectrometer and the portable computer, and a carrier for the portable FT-NIR spectrometer, the portable computer, and the portable electric power source. The on-site mobile device is configured to send data to and receive data from the remote-site computer to control and display the portable computer. The remote site computer is operably configured to send data to and receive data from the on-site mobile device and the portable computer which is controlled by the on-site mobile device.

Also disclosed is a method for on-site nondestructive analysis of a material sample, the method comprising the step of, in combination, obtaining an on-site portable data collection device comprising a portable Fourier-Transform Near-Infrared (FT-NIR) spectrometer operable with a DC power input, a hand-held probe having a large sampling area and operably connected to the portable FT-NIR spectrometer, a portable computer operable with a DC power input and configured for operation of the FT-NIR spectrometer and operably configured to send data to and receive data from a remote-site computer, a portable electric power source operably connected to the portable FT-NIR spectrometer and the portable computer for providing a DC power output to the portable FT-NIR spectrometer and the portable computer; and a carrier for the portable FT-NIR spectrometer, the portable computer, and the portable electric power source. The method further includes the steps of obtaining an on-site mobile device configured to send data to and receive data from the remote-site computer and to control and display the portable computer, directing the hand-held probe at the material sample, activating the portable FT-NIR spectrometer to obtain a spectra from the material sample, wirelessly sending the spectra from the portable computer to the remote-site computer, analyzing the spectra at the remote site to obtain desired trait results for the material sample, and sending the desired trait results from the remote-site computer to the portable computer and displaying the trait results on a screen of the mobile device. The method preferably includes storing the spectra and the trait results at the remote site.

From the foregoing disclosure and the following more detailed description of various preferred embodiments it will be apparent to those skilled in the art that the present invention provides a significant advance in the technology and art of systems, methods and devices for on-site rapid, direct, and nondestructive analysis of materials using portable high performance NIR analyzers. Particularly significant in this regard is the potential the invention affords for providing a portable high performance NIR analyzer that provides on-site rapid and accurate results. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a diagrammatical view of a system for on-site rapid, direct, and nondestructive analysis of materials according to the present invention.

FIG. 2 is a diagrammatical view of a remote-site server/computer of the system of FIG. 1.

FIG. 3 is a diagrammatical view of an on-site mobile device of the system of FIG. 1.

FIG. 4 is a diagrammatical view of an on-site portable data collection device of the system of FIG. 1.

FIG. 5 is a view of a user or analyst on-site with the mobile device of FIG. 3 and the portable data collection device of FIG. 4.

FIG. 6 is a right side view of the user or analyst holding a hand-held probe of the on-site portable data collection device of FIG. 4.

FIG. 7 is a diagrammatic view of a the portable/minicomputer of the data collection device of FIG. 4.

FIG. 8 is a screen view of a login page of an application running on the on-site mobile device of FIG. 3.

FIG. 9 is a screen view of a system start-up page of the application running on the on-site mobile device of FIG. 3.

FIG. 10 is a screen view of a material selection page of the application running on the on-site mobile device of FIG. 3.

FIG. 11 is a screen view of a sample identification page of the application running on the on-site mobile device of FIG. 3.

FIG. 12 a screen view of a traits selection page of the application running on the on-site mobile device of FIG. 3.

FIG. 13 a perspective view of the user or analyst engaging a material sample with the hand-held probe of the on-site data collection device of FIG. 4.

FIG. 14 a screen view of an exemplary trigger page of the application running on the on-site mobile device of FIG. 3.

FIG. 15 a screen view of an exemplary analyzing page of the application running on the on-site mobile device of FIG. 3.

FIG. 16 a screen view of an exemplary calculating results page of the application running on the on-site mobile device of FIG. 3.

FIG. 17 a screen view of an exemplary success/failure page of the application running on the on-site mobile device of FIG. 3.

FIG. 18 a screen view of an exemplary results page of the application running on the on-site mobile device of FIG. 3.

It should be understood that the appended drawings are not necessarily to scale, presenting a somewhat simplified representation of various preferred features illustrative of the basic principles of the invention. The specific design features of the system and its components as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the items illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the systems, methods, and software disclosed herein for on-site rapid, direct, and nondestructive testing of materials. The following detailed discussion of various alternative and preferred embodiments will illustrate the general principles of the invention with regard to systems, methods, and devices disclosed herein for on-site rapid, direct, and nondestructive analysis of cannabis. Other embodiments of the present invention suitable for other applications will be apparent to those skilled in the art given the benefit of this disclosure.

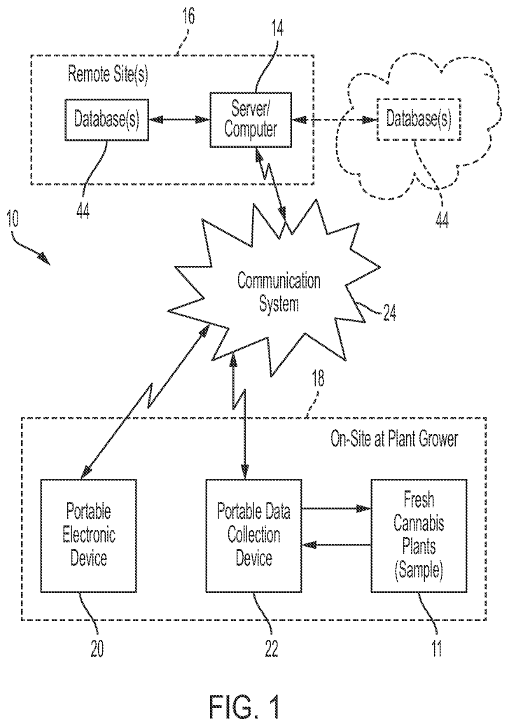

Referring now to the drawings, FIG. 1 illustrates a system 10 for on-site rapid, direct, and nondestructive analysis of a material sample 11 using a portable high performance near-infrared spectroscopy device or analyzer 12 (sometimes referred to as a spectrometer) according to the present invention. The illustrated system 10 is configured to analyze key parameters of cannabis such as, for example but not limited to, CBD (cannabidiol), THC (tetrahydrocannabinol), total terpenes, and other parameters for use ion-site in a greenhouse setting or in a growing field. The system 10 can be used, for example but not limited to, to nondestructively analyze a floral on a live cannabis plant or samples collected in a growing field. However, this system 10 can alternatively be configured for analyzing any other suitable materials. The system 10 can be configured as a general analyzer covering applications for multiple industries or it can be configured for a specified application. For example, but not limited to, the system 10 can be configured as: (1) a portable meat analyzer to analyze, for example but not limited to, moisture, fat, and protein of, for example but not limited to, beef, and pork; (2) a portable fruit analyzer to analyze, for example but not limited to, moisture, dry matters, and brix of fruits; (3) a portable nuts analyzer to analyze, for example but not limited to, fat, moisture, protein, fiber, total sugar, and carbohydrates of nuts such as, for example but not limited to, almonds, cashews, and walnuts; and (4) a portable limestone analyzer to analyze, for example but not limited to, calcium carbonate, magnesium carbonate, silicon oxide and other compositions on the wall in a mine.

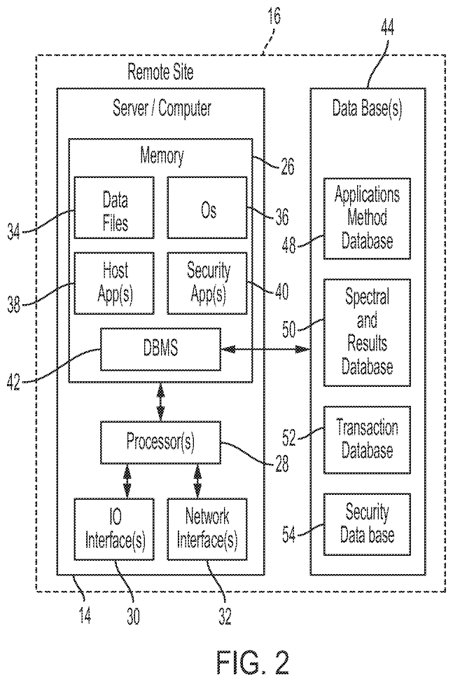

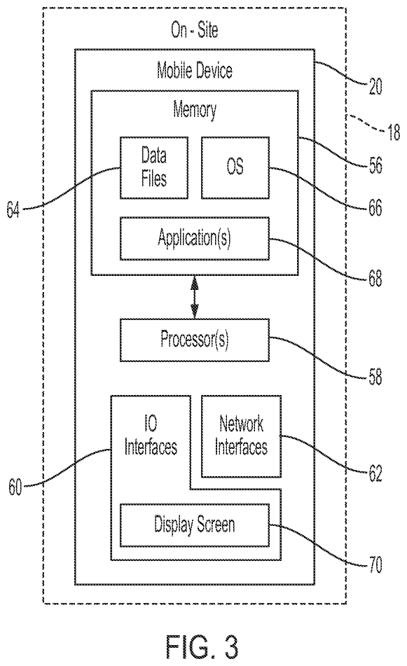

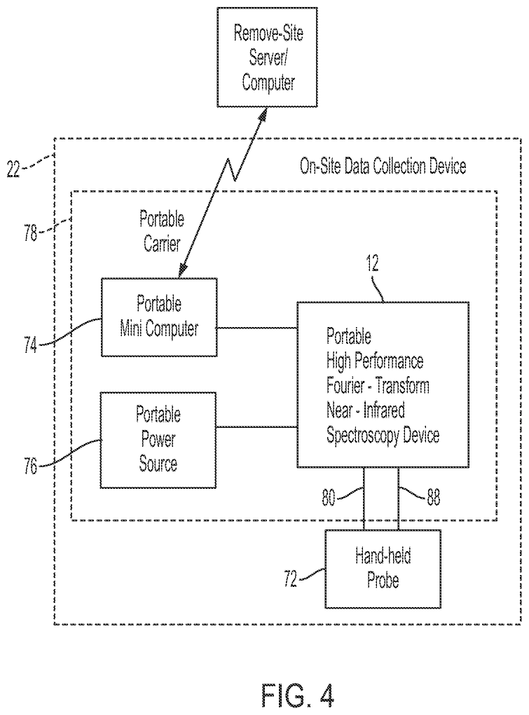

The illustrated system 10 includes at least one service provider server or computer 14 (best shown in FIG. 2) located at a service provider or remote location 16 that is remote from the on-site analysis or test location 18, at least one mobile device or portable electronic device 20 (best shown in FIG. 3) of the user or analyst located on-site at the analysis or test location 18, and at least one portable data collection device 22 (best shown in FIG. 4) located on-site at the analysis or test location 18. The on-site analysis or test location 18 can be, for example but not limited to, a growing field, a greenhouse, a grow room, and the like where the fresh cannabis plants are growing. The term “server” is used in the specification and claims to mean a computer configured to manage, store, send and process data 24-hours a day. The term “computer” is used in the specification and claims to mean any electronic device that can suitably communicate via a communications system or network including, but not limited to, desktop computers, laptop computers, notebook computers, tablet computers, smart phones, personal digital assistants (PDAs), and the like. The terms “mobile device” and “portable electronic device” are used in the specification and claims to mean a handheld electronic device that utilizes rechargeable batteries as a power source and that that can suitably communicate with the computer described above including, but not limited to, smart phones, personal digital assistants (PDAs), mp3 or other music players, video game players, messaging systems, tablet computers, notebook computers, and the like.

The illustrated service provider server/computer 14, the illustrated user mobile device 20, and the illustrated portable data collection device 22 are in electronic communication with one another via a communication system or network 24. The illustrated communication system 24 is a computer network such as the Internet but any other suitable communication system can alternatively be utilized such as, for example, an intranet, any other type network of computers, and the like.

As best shown in FIG. 2, an exemplary service provider server/computer 4 includes memory 26, at least one processor or central processing units (CPU) 28 in communication with the memory 26, one or more input output (IO) interfaces 30 in communication with the processor 28, and at least one network interface 32 in communication with the processor 28, all of which is configured to carry out the functions and steps described herein. The illustrated memory 26 stores data files 34, an operating system (OS) 36, host applications 38 for communications with web browsers and mobile applications, security applications 40 for limiting access to authorized users, and a database management system 42 for interfacing with databases having application methods, and stored information. It is noted that any other suitable information and/or software can be stored in the processor 28 and/or the memory 26. The illustrated databases 44 are separate from the service provider server/computer 14 but it is noted that the databases 44 can alternatively be integrated with the service provider server/computer 14. The illustrated databases 44 are located at the remote site or location 16 and/or a cloud location 46 but it is noted that the databases 44 can alternatively be located at any other suitable location and/or be of any other suitable type. The illustrated databases 44 include an application methods database 48, a spectral and results database 50, a transaction database 52, and a security database 52 but any other suitable types of databases can alternatively and/or additionally be utilized. The at least one processor 28 can be of any suitable type. The at least one IO interface 30 can be of any suitable type such as, for example but not limited to, a keyboard, a mouse, a track ball, a touch pad, a camera, a speaker, a monitor or display screen, a printer, a modem, a disk drive and the like. The network interface 32 can be of any suitable type such as, for example but not limited to, a network interface chip, software simulating a network card, and the like. The illustrated processor 28 and memory 26 are programmed with computer software including providing a web portal for interfacing with the user mobile device 20 and the portable data collection device 22 as described in more detail hereinafter. It is noted that the server/computer can alternatively have any other suitable configuration.

The illustrated service provider server/computer 14 is located at the service provider remote site 86, that is remote from the analysis or test location 18, and can be accessed by the user or analyst via the communication system 24. It is noted that while the illustrated system 10 shows a single user or analyst, it should be appreciated that the service provider server/computer 14 provides such services to a plurality of different users or analysts. It is further noted that the service provider server/computer 14 is not necessarily physically located at physical facilities of the service provider. In many instances the system is cloud based.

The illustrated remote-site service provider server/computer 14 and its associated database(s) 48 to 52 are provided with suitable software and data to perform a Chemometric based analysis. The Chemometric based analysis applies algorithms for a specific material type to the infrared spectra data for a sample 11 of that material type received from the spectrometer 12 in order to obtain trait data for the material sample 11 based on the spectra data obtained by the spectrometer 12 as discussed in more detail hereinbelow. For descriptions of suitable Chemometric based analysis performed by remote platforms, see U.S. Pat. Nos. 6,751,576, 6,872,946, 7,194,369, and 8,010,309, the disclosures of which are expressly incorporated herein in their entireties by reference.

As best shown in FIG. 3, an exemplary user mobile device 20 includes memory 56, at least one processor or central processing units (CPU) 58 in communication with the memory 56, one or more input/output (IO) interfaces 60 in communication with the processor 58, and at least one network interface 62 in communication with the processor 58, all of which is configured to carry out the functions and steps described herein. The illustrated memory 56 stores data files 64, an operating system (OS) 66, and a mobile application(s) 68. It is noted that any other suitable information and/or software can be stored in the processor 58 and/or memory 56. The at least one processor 58 can be of any suitable type. The at least one IO interface 60 includes a display screen 70 and can further include any suitable type such as, for example but not limited to, a keyboard, a mouse, a track ball, a touch pad, a camera, a speaker, a touch screen, and the like. The network interface 62 can be of any suitable type such as, for example but not limited to, a network interface chip, software simulating a network card, Wi-Fi, Bluetooth, infrared, radio wave, and the like. The illustrated processor 58 and memory 56 are programmed with the mobile app or application 68 for communicating with the web portal of the service provider server/computer 14 and the portable data collection device 22 as described in more detail hereinafter. The terms “mobile app” and “mobile application” are used in the specification and claims to mean a type of application software designed to run on a mobile device or computer to provide users or analysts with similar services to those accessed on personal computers. It is noted that the mobile device 20 can alternatively have any other suitable configuration.

The illustrated user mobile device 20 is typically physically located with the user or analyst, that is physically located on-site testing location 18 with the materials to be analyzed, but it is appreciated that other than during the analysis (and time immediately surrounding the analysis), the user mobile device 20 will likely be in other locations because the user mobile device 20 is mobile. It is noted that that while the illustrated system 10 shows a single user or analyst having a single mobile device 20, it should be appreciated that there is typically more than one user or analyst having one or more mobile devices 20. The illustrated user mobile device 20 is also in electronic communication with the portable data collection device 22 at the on-site analysis or testing location 18 via the remote-site server/computer 14 as described in more detail below. Preferably, the mobile device 20 is in electronic communication with the communication system 24 via a wireless cellular system or the like and the portable data collection device 22 is in electronic communication with the communication system 24 via a local wireless protocol such as Wi-Fi. The Wi-Fi can be a company Wi-Fi, a separate hot-spot or mobile phone hot-spot etc. Alternatively they can be in communication via any other suitable wireless or wired means.

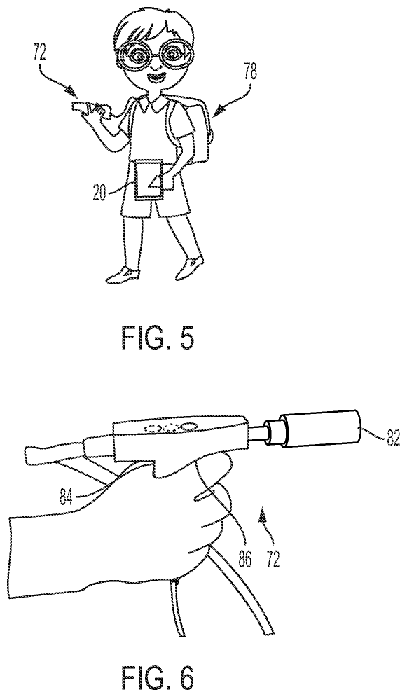

As best shown in FIGS. 4 and 5, the illustrated portable data collection device includes a portable high performance Fourier Transfer Near-Infrared (FT-NIR) spectroscopy device or analyzer 12, a hand-held probe 72 for direct contact or non-contact with the material to be analyzed and operably connected to the portable high performance FT-NIR analyzer 12, a portable computer 74 operably in communication with the portable high performance FT-NIR analyzer 12 and the mobile device of the user or analyst (via the remote server/computer 14), and a portable electric power source 76 operably connected to the portable high performance FT-NIR analyzer 12, and the portable computer 74. The illustrated portable data collection device 22 also includes a suitable carrier 78 such as, for example but not limited to, the illustrated backpack, a shoulder bag or container, a handled bag or container, a carrier with wheels, and the like so that the user or analyst can easily carry each of the components of the portable data collection device 22 to the fresh cannabis plants or other materials to be analyzed on-site. Thus, collectively, the components must have a suitable size and weight to permit the portable data collection device 22 to be carried by the user or analyst in this manner. It is noted that the portable data collection device 22 can alternatively have any other suitable configuration.

The illustrated high performance FT-NIR spectroscopy device or analyzer 12 of the portable data collection device 22 is small and light weight enough to be used as a portable spectrometer or analyzer. Benchtop spectrometers are not suitable to be a portable spectrometers or analyzers due to their size and weight. The illustrated high performance FT-NIR spectrometer is a fiber optic type spectrometer so that it can be suitably coupled with a fiber optic sampling device composed of fiber optic cables and a fiber optic probe as described in more detail herein below. The illustrated portable high performance FT-NIR spectrometer 12 also operates with an input of 12V DC power but alternatively can operate on any other suitable DC voltage. The illustrated portable high performance FT-NIR spectrometer 12 and the probe 72 have the ability to collect a spectrum covering the full near infrared spectral range. It is noted that the portable high performance FT-NIR spectrometer 12 can alternatively have any other suitable configuration.

As best shown in FIG. 6, the illustrated hand-held probe 72 of the portable data collection device 22 is a fiber optic type probe that is connected to the fiber optic type portable FT-NIR spectrometer 12 with at least one fiber optic cable 80. The illustrated hand-held probe has a sampling window 82 with a large sampling or illuminating area, that is, a sampling area with a diameter of at least 8 mm, and preferably a sampling area with a diameter of 10 to 20mm. This large sampling area provides improved results for the measurement of nonhomogeneous samples. The full range of the NIR Spectrometer is compatible with the probe. The illustrated hand-held probe 72 has a gun-like configuration with a hand grip 84 opposite the sampling end or window 82 so that the sampling window can easily be positioned at a desired location. The hand-held probe 72 also includes an activation trigger 86 slightly forward of the handgrip 84 so that the hand-held probe 72 can be operated with one hand. The activation trigger 86 is used to active the portable FT-NIR spectrometer 12 to analyze the sample 11. The hand-held probe is connected to the portable FT-NIR spectrometer with at least one electric cable 88 and the at least one fiber optic cable 80 and can be used to control the operation of the portable FT-NIR spectrometer 12 directly. It is noted that the hand-held probe 72 can alternatively have any other suitable configuration.

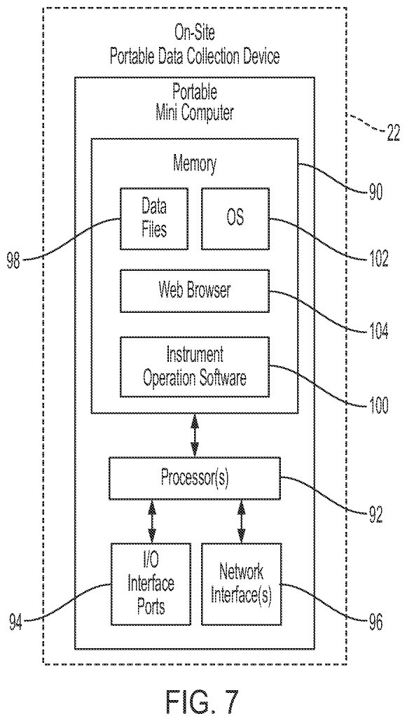

As best shown in FIG. 7, the illustrated portable computer 74 of the portable data collection device 22 is includes memory 90, at least one processor or central processing units (CPU) 92 in communication with the memory, one or more input/output (IO) interfaces 94 in communication with the processor 92, and at least one network interface 96 in communication with the processor 92, all of which is configured to carry out the functions and steps described herein. The illustrated memory 90 stores data files 98, an instrument operation software 100, an operating system (OS) 102, and a web browser 104. It is noted that any other suitable information and/or software can be stored in the processor 92 and/or memory 90. The at least one processor 92 can be of any suitable type. The at least one IO interface 94 can be of any suitable type such as, for example but not limited to, a keyboard, a mouse, a track ball, a touch pad, a camera, a speaker, a monitor, a printer, a modem, a disk drive and the like. The network interface 96 can be of any suitable type such as, for example but not limited to, a network interface card, software simulating a network card, and the like. The illustrated portable computer is a mini computer or mini PC. A mini computer or mini PC Mini is a variant of computers that possesses most of the features and capabilities of a large computer but is smaller in physical size and weight. While mini computers have ports for physical input/out/put devices they typically have no physical input/output devices such as, for example but not limited to, a keyboard, a mouse, a track ball, a touch pad, a camera, a speaker, a monitor (display screen), a printer, a modem, a disk drive, and the like. This enables them to have a relatively small physical size and weight. The illustrated portable computer 74 also operates with an input of 12V DC power but alternatively can operate on any other suitable DC voltage. It is noted that the portable computer 74 of the portable data collection device 22 can alternatively have any other suitable configuration.

The illustrated portable electric power source 76 of the portable data collection device 22 is a commercial electric power bank with a 12V DC power output but alternatively can output any other suitable DC voltage. The illustrated portable electric power source 76 includes one or more rechargeable batteries such as, for example but not limited to, rechargeable lithium batteries. The portable electric power source 76 preferably provides suitable electric power for operating the portable computer 74 and the portable high performance FT-NIR spectroscopy device 12 for at least 8 hours. It is noted that the portable electric power source 76 can alternatively have any other suitable configuration.

The illustrated system software or web platform resides at the service provider server/computer 14 and is accessible to the user or analyst via the applications on the portable computer 74 of the on-site portable data collection device 22 and on the mobile device 20 of the onsite user or analyst.

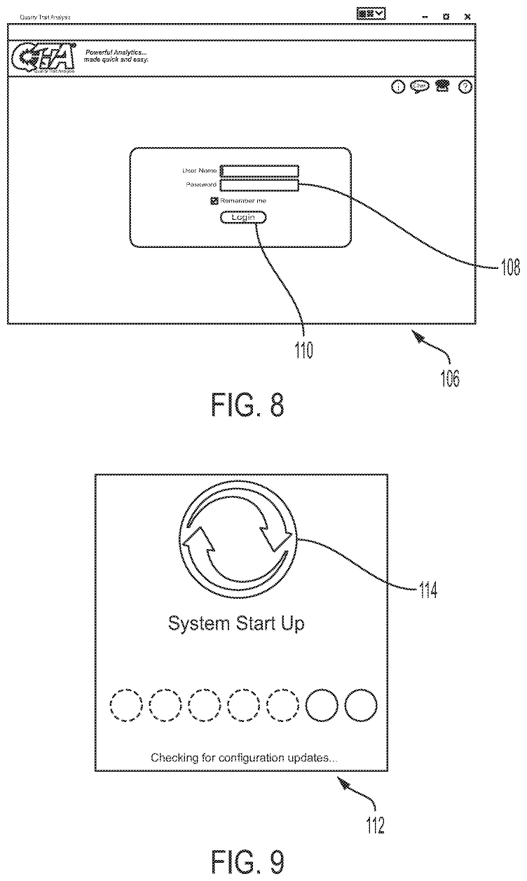

A method for analyzing a dried cannabis sample or a fresh cannabis plant utilizing the above described system will now be described. First, an on-site user or analyst with the mobile device 20 and the portable data collection device 22 identifies a dried cannabis sample or a sample fresh cannabis plant for analysis. Next the user or analyst starts the application on their mobile device 20. FIG. 8 illustrates an exemplary application home or login page or screen 106 displayed on the display 70 screen of the on-site mobile device 20 of the user or analyst. The illustrated home page 106 displays data fields 108 in which the user or analyst must enter a user name and password. If the user or analyst wants to login again at a later time, they can click on a “remember me” checkbox. Once completed, the user or analyst clicks on a login button 110. It is noted that the login page 108 can alternatively have any other suitable configuration.

Once the user or analyst clicks on the login button 110 on the login page 106, a startup page or screen 112 is displayed on the display screen 70 of the on-site mobile device 20 of the user or analyst. FIG. 9 illustrates an exemplary startup page or screen displayed on the display screen 70 of the on-site mobile device 20 of the user or analyst. The illustrated startup page 112 displays a wait symbol 114. While this startup page 12 is displayed, the mobile device 20 starts to communicate with the remote server/computer 14 and determines if there are any unloaded application updates and downloads any necessary files. For a first time login, this process typically takes about 2 minutes. It is noted that the startup page 112 can alternatively have any other suitable configuration.

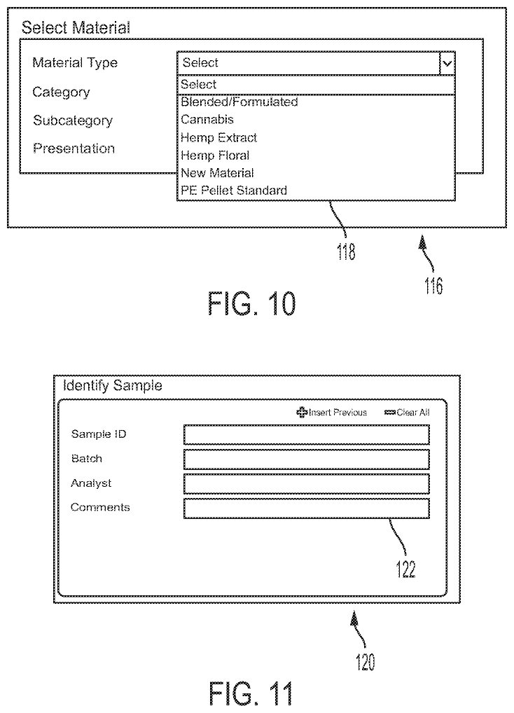

Once the startup process is complete, a material selection page or screen 116 is displayed on the display screen 70 of the on-site mobile device 20 of the user or analyst. FIG. 10 illustrates an exemplary material selection page or screen 116 displayed on the display screen 70 of the on-site mobile device 20 of the user or analyst with which the user or analyst can select the material of the sample that will be analyzed. The illustrated material selection page displays a plurality of drop down lists 118 for the user or analyst to select, a material type, a category, a subcategory, and a presentation. The illustrated material type selections are Blended/Formula, Cannabis, Hemp Extract, Hemp Floral, New material, and PE Pellet Standard. The possible selections for the remaining list are determined based on the material type selection. The material list can be configured according to different user accounts. Once the material type is selected, the user or analyst proceeds to makes selections from the Category, Subcategory, and Presentation lists. It is noted that the material selection page 116 can alternatively have any other suitable configuration.

Once the selections of the material selection page 116 are complete, a sample identification page or screen 120 is displayed on the display screen 7 of the on-site mobile device 20 of the user or analyst. FIG. 11 illustrates an exemplary sample identification page or screen 120 displayed on the display screen 70 of the on-site mobile device 20 of the user or analyst with which the user or analyst can identify the sample that will be analyzed. The illustrated sample identification page 120 displays a plurality of data fields 122 for the user or analyst to input a sample ID, a Batch, the analyst, and comments. It is noted that the sample identification page 120 can alternatively have any other suitable configuration.

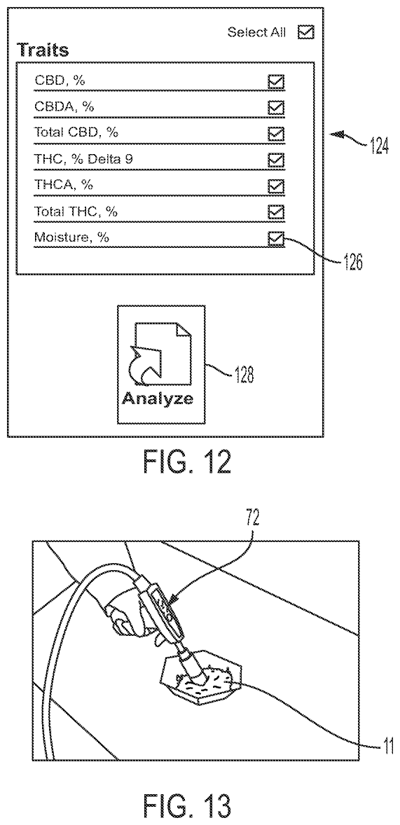

Once the input of information on the sample identification page 120 is complete, a traits identification page or screen 124 is displayed on the display screen 70 of the on-site mobile device 20 of the user or analyst. FIG. 12 illustrates an exemplary traits identification page or screen 214 displayed on the display screen 70 of the on-site mobile device 20 of the user or analyst with which the user or analyst can identify the traits that will be later determined and displayed. The illustrated traits identification page 124 displays a plurality of checkboxes 126 for the user or analyst to select CBD %, CBDA %, total CBD %, THC % Delta 9, THCA %, Total THC %, and moisture %. The illustrated traits identification page 124 also includes an analyze button 128 for beginning an analysis process. It is noted that the traits identification page 124 can alternatively have any other suitable configuration.

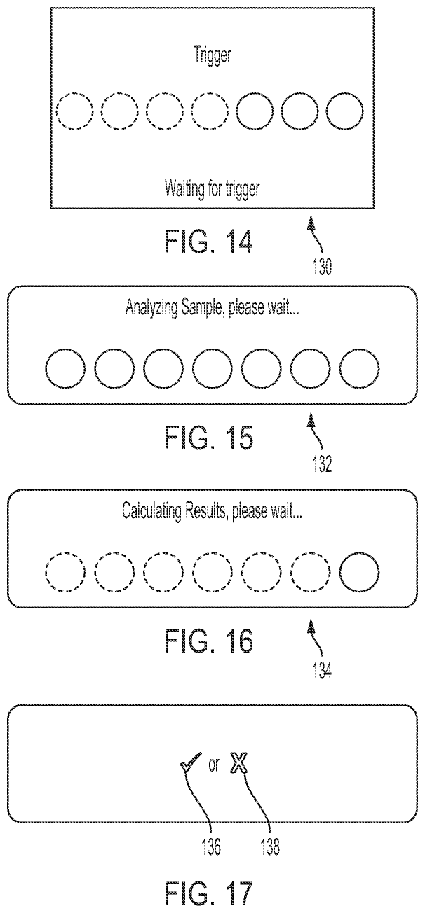

Once the user or analyst clicks on the analyze button 128, the user or analyst grasps the hand-held probe 72 of the on-site data collection device 22 and directs the sampling window 82 of the hand-held probe 72 directly at the material of the sample to be analyzed (best shown in FIG. 13). The user or analyst can point or direct the sampling window 82 of the hand-held probe 72 to the sample with or without a gap depending on the applications. During this time, a trigger page or screen 130 is displayed on the display screen 70 of the on-site mobile device 20 of the user or analyst. FIG. 14 illustrates an exemplary trigger page or screen 130 displayed on the display screen 70 of the on-site mobile device 20 of the user or analyst with which prompts the user or analyst to pull the trigger 86 of the hand-held probe 72 that is directed at the sample to be analyzed. It is noted that the trigger page 130 can alternatively have any other suitable configuration.

Once the user or analyst pulls the trigger 86 of the hand-held probe 72, an analyzing sample page or screen 132 is displayed on the display screen 70 of the on-site mobile device 20 of the user or analyst and the portable FT-NIR spectrometer 12 begins scanning the sample. Near Infrared light emerges from the sampling window 82 of the hand-held probe 72 and penetrates the sample to be analyzed. Light reflected back from the sample enters the sampling window 82 of the hand-held probe 72 and is sent to NIR detectors of the portable FT-NIR spectrometer 12. A near infrared spectrum or spectra is created and sent to the remote-site server/computer 14 via the portable computer 74 connected to the FT-NIR spectrometer 12. FIG. 15 illustrates an exemplary analyzing sample page or screen 132 displayed on the display screen 72 of the on-site mobile device 20 of the user or analyst with which indicates to the user or analyst that the analysis of the sample is in progress so “please wait” and do not release the trigger 86 or remove the hand-held probe from the sample. It is noted that the analyzing sample page 132 can alternatively have any other suitable configuration.

Once the spectra is created and sent to the remote server/computer 14, a calculating results page or screen 134 is displayed on the display screen 72 of the on-site mobile device 20 of the user or analyst. Also, the remote-site server/computer 14 automatically applies appropriate chemometric algorithms for analyzing the material to the near infrared spectrum for the sample of material received from the portable computer 74 to generate results for the selected traits, and sends the results back the portable computer 74 and displayed on the on-site mobile device 20. FIG. 16 illustrates an exemplary calculating results page or screen 134 displayed on the display screen 70 of the on-site mobile device 20 of the user or analyst which indicates to the user or analyst that the calculating results of the analysis is in progress so “please wait”. It is noted that the calculating results page 134 can alternatively have any other suitable configuration. A best shown in FIG. 17, once calculation of results is complete, a green check mark or other positive indication 136 will flash on the display screen 70 if the spectra was good or a red X or other negative indication 138 will flash on the display screen 70 if the spectra was bad.

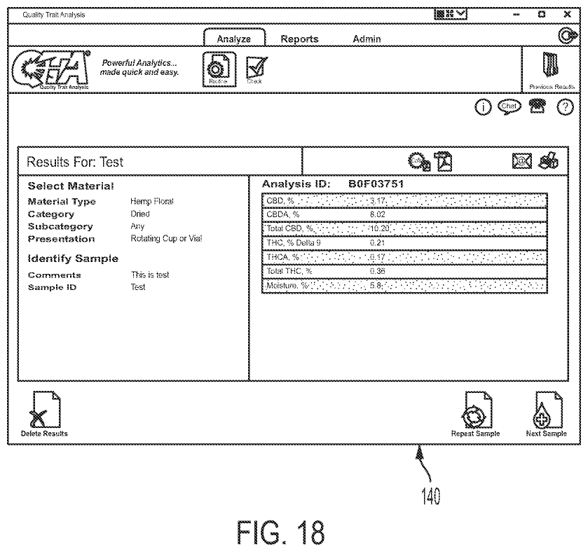

Once calculation of results is complete, assuming the near infrared spectra was good, a results page or screen 140 is displayed on the display screen 70 of the on-site mobile device 20 of the user or analyst. FIG. 18 illustrates an exemplary results page or screen 140 displayed on the display screen 70 of the on-site mobile device 20 of the user or analyst which indicates to the user or analyst the results of the analysis. Additionally, the near infrared spectrum and the results of the analysis are stored at the remote site computer/server 14 and can be viewed anytime thereafter by going to the reports tab. It is noted that the results page 140 can alternatively have any other suitable configuration.

Using cannabis analysis as an example, our experience when analyzing cannabis and hemp placed in a cup on commercially-available benchtop NIR spectrometers has been that for fresh material harvested without drying, the accuracy of the analysis is considerably weaker than for material that has been dried. Analyzing the same parameters when the plant material is dried and ground has been much more successful. This is expected for NIR since the presence of water greatly weakens the signal due to the high absorbance of water. However, it is often advantageous to take a measurement on plant material while it is still growing and unharvested. The present invention now makes that possible. Our strategy for measuring whole, unground plant material is to take at least 3 measurements of the material (i.e., for a bud or cone, three different parts of the surface), then to average the results. This has allowed for accuracy of our new portable technologies to be comparable to our current benchtop technologies. For example, the measurement accuracy of Delta-9-Tetrahydrocannabinol (THC), which is one of the key cannabinoids for hemp and cannabis, is 0.03% for fresh material measured with the new portable technology. This kind of accuracy is impossible for the existing handheld NIR devices (with the THC accuracy lager than 1%) to achieve. This is the also same accuracy as for our current NIR benchtop technologies for dried cannabis and dried hemp, which is also 0.03%. Now, cannabis can be measured in a greenhouse or field, as it grows, without destroying the crop by harvesting and drying the sample. The THC and other important cannabinoids can be monitored conveniently, and the accuracy achieved with our multi-point measurement and averaging strategy. Since the portable scanning and cloud-based analysis can take as little as 1 minute, several data points can be taken on the same sample to achieve the same performance as a large benchtop instrument which requires a table and an extracted portion of sample which must fill a cup.

Any of the features or attributes of the above described embodiments and variations can be used in combination with any of the other features and attributes of the above described embodiments and variations as desired.

It is apparent from the forgoing disclosure and detailed description that the system of the present invention is effective to provide improved nondestructive analysis of materials on-site. In particular, (1) a wider range of applications and higher accuracy/performance and spectral quality is obtained than with current portable NIR analyzers; (2) the probe has a larger sampling area for obtaining a more representative spectral signature than is obtained from current probes; (3) the cloud based analysis methods allow the NIR analyzer to have methods developed and maintained by expert chemometricians remotely; and (4) a “lab quality” high performance spectrometer is provided which is user-friendly and can be operated without specialized training.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A portable data collection device comprising, in combination:
a portable Fourier-Transform Near-Infrared (FT-NIR) spectrometer operable with a direct current (DC) power input;
a hand-held probe having a large sampling area and operably connected to the portable FT-NIR spectrometer;
a portable computer operable with a DC power input and configured for operation of the FT-NIR spectrometer;
a portable electric power source operably connected to the portable FT-NIR spectrometer and the portable computer for providing a DC power output to the portable FT-NIR spectrometer and the portable computer; and
a carrier for the portable FT-NIR spectrometer, the portable computer, and the portable electric power source.

2. The portable data collection device according to claim 1, wherein the carrier is a backpack.

3. The portable data collection device according to claim 1, wherein the portable FT-NIR spectrometer is a fiber optic type spectrometer, the hand-held probe is a fiber optic type probe, and the hand-held probe is connected to the portable FT-NIR spectrometer with at least one fiber optic cable.

4. The portable data collection device according to claim 1, wherein the hand held probe has a sampling area with a diameter of at least 8 mm.

5. The portable data collection device according to claim 4, wherein the hand held probe has a sampling area with a diameter of 10 to 20 mm.

6. The portable data collection device according to claim 1, wherein the hand held probe has a hand grip and a trigger, and wherein the trigger is configured to activate the portable FT-NIR spectrometer to analyze a sample.

7. The portable data collection device according to claim 1, the portable computer is a minicomputer.

8. A system for on-site nondestructive analysis of a material sample, the system comprising, in combination:
a remote-site computer and a remote-site database in communication with the remote-site computer;
an on-site portable data collection device comprising:
a portable Fourier-Transform Near-Infrared (FT-NIR) spectrometer operable with a direct current (DC) power input;
a hand-held probe having a large sampling area and operably connected to the portable FT-NIR spectrometer;
a portable computer operable with a direct current power input and configured for operation of the FT-NIR spectrometer and operably configured to send data to and receive data from the remote-site computer;
a portable electric power source operably connected to the portable FT-NIR spectrometer and the portable computer for providing a DC power output to the portable FT-NIR spectrometer and the portable computer; and
a carrier for the portable FT-NIR spectrometer, the portable computer, and the portable electric power source;
an on-site mobile device configured to send data to and receive data from the remote-site computer to control and display the portable computer; and
wherein the remote site computer is operably configured to send data to and receive data from the on-site mobile device and the portable computer which is controlled by the on-site mobile device.

9. The system according to claim 8, wherein the carrier is a backpack.

10. The system according to claim 8, wherein the portable FT-NIR spectrometer is a fiber optic type spectrometer, the hand-held probe is a fiber optic type probe, and the hand-held probe is connected to the portable FT-NIR spectrometer with at least one fiber optic cable.

11. The system according to claim 8, wherein the hand held probe has a sampling area with a diameter of at least 8 mm.

12. The system according to claim 11, wherein the hand held probe has a sampling area with a diameter of 10 to 20 mm.

13. The system according to claim 8, wherein the hand held probe has a hand grip and a trigger, and wherein the trigger is configured to activate the portable FT-NIR spectrometer to analyze a sample.

14. The system according to claim 8, wherein the portable computer is a minicomputer.

15. Method for on-site nondestructive analysis of a material sample, the method comprising the steps of, in combination:
obtaining an on-site portable data collection device comprising:
a portable Fourier-Transform Near-Infrared (FT-NIR) spectrometer operable with a direct current (DC) power input;
a hand-held probe having a large sampling area and operably connected to the portable FT-NIR spectrometer;
a portable computer operable with a DC power input and configured for operation of the FT-NIR spectrometer and operably configured to send data to and receive data from a remote-site computer;
a portable electric power source operably connected to the portable FT-NIR spectrometer and the portable computer for providing a DC power output to the portable FT-NIR spectrometer and the portable computer; and
a carrier for the portable FT-NIR spectrometer, the portable computer, and the portable electric power source;
obtaining an on-site mobile device configured to send data to and receive data from the remote-site computer to control and display the portable computer;
directing the hand-held probe at the material sample;
activating the portable FT-NIR spectrometer to obtain a spectra from the material sample;
wirelessly sending the spectra from the portable computer to the remote-site computer;
analyzing the spectra at the remote site to obtain desired trait results for the material sample; and
sending the desired trait results from the remote-site computer to the portable computer and displaying the trait results on a screen of the mobile device.

16. The method according to claim 15, further comprising the step of storing the desired trait results on a database of the remote-site computer.

17. The method according to claim 15, wherein the carrier is a backpack.

18. The method according to claim 15, wherein the portable FT-NIR spectrometer is a fiber optic type spectrometer, the hand-held probe is a fiber optic type probe, and the hand-held probe is connected to the portable FT-NIR spectrometer with at least one fiber optic cable.

19. The method according to claim 15, wherein the hand held probe has a sampling area with a diameter of at least 8 mm.

20. The method according to claim 19, wherein the hand held probe has a sampling area with a diameter of 10 to 20 mm.

21. The method according to claim 15, wherein the hand held probe has a hand grip and a trigger, and wherein the trigger is configured to activate the portable FT-NIR spectrometer to analyze a sample.

22. The method according to claim 15, wherein the mobile device is configured to wirelessly control and display the portable computer.
